(19) United States
(12) Patent Application Publication
(10) Pub. No.: US 2013/0097097 A1
(43) Pub. Date: Apr. 18, 2013

(54) METHODS AND SYSTEMS FOR MANAGING LONGEVITY RISK

(71) Applicants: James Valentino, New York, NY (US); Menachem Brenner, New York, NY (US); Eli Garber, Ramat Hashron (IL); Michael Davidson, Tel Aviv (IL); Meir Sokoler, Jerusalem (IL)

(72) Inventors: James Valentino, New York, NY (US); Menachem Brenner, New York, NY (US); Eli Garber, Ramat Hashron (IL); Michael Davidson, Tel Aviv (IL); Meir Sokoler, Jerusalem (IL)

(21) Appl. No.: 13/611,461

(22) Filed: Sep. 12, 2012

Related U.S. Application Data
(63) Continuation of application No. 11/936,481, filed on Nov. 7, 2007, now abandoned.
(60) Provisional application No. 60/857,689, filed on Nov. 7, 2006.

(51) Int. Cl. G06Q 40/06

(52) U.S. Cl. CPC G06Q 40/06
USPC 705/36 R

(57) ABSTRACT

A method for managing risk of longevity is presented in which transactions with supplier and demander entities which benefit from longevity increases or decreases, respectively, are hedged by an intermediary. For example, the intermediary may purchase a first bond from a first entity and sell a second bond to a second entity. Each of the bonds may be linked to a longevity statistic or index.

### CROSS REFERENCE TO RELATED APPLICATIONS

This application claims priority to U.S. Provisional Patent Application No. 60/857,689, filed Nov. 7, 2006. The entire contents of that provisional application are incorporated herein by reference.

### INTRODUCTION

Improved sanitation, reductions in infant mortality rates, and control of infectious diseases over recent years have contributed to an increase in life expectancy. In the last fifty years, healthier lifestyles in middle and old age, and progress in cardiovascular medicine and cancer treatment also have contributed to increased average life duration. A trend of increasing life expectancy is expected to continue because large proportions of the populations have healthier lifestyles and medical technology is expected to continue improving. Extended life spans, approaching retirements of a massive number of baby-boomers, and a worldwide shift towards defined contribution pension systems have created enormous pressures for financial innovations that deal directly with the elderly and the uncertainty surrounding their longevity.

New financial solutions are required not only to deal with the circumstances of the current generation of elderly people but also with future generations. In particular, individuals are going to live unpredictably longer lives; spend more years in retirement, may be dependents of others (or the state), and may require expensive treatment. Faced with longer lives and unpredictable health expenses, individuals wish to ensure that they do not outlive their financial resources. Currently such individuals may resort to inefficient and/or expensive strategies designed to provide for their potentially longer than expected lives, such as selling their home or other assets. Solutions are needed that deal with longevity risk directly, and are more efficient and less expensive than current strategies. Longevity risk also is a concern for institutions to which the individuals turn, including pension funds, life insurance companies, life annuity providers, and governments.

States like Florida or Arizona are good candidates to be “suppliers” of protection against unanticipated increases in longevity because each state attracts an elderly population which may be a net contributor to the state's taxes and income. There are several other states similar to Florida in demographic characteristics, and countries, such as Italy, Japan, Australia, and others. These states and countries have an increasingly aging population that may have, in some of their regions, similar experiences to that of Florida. Similarly, organizations that provide support to dependent elderly, such as chains of protected housing, nursing homes, and the healthcare industry, are positioned to profit from increased longevity.

However, due to the unpredictability of life durations, states, countries and organizations catering to the elderly are not immune from the risk of shorter than expected life duration. In the event that an individual life span was shorter than expected, such states, countries and organizations would suffer from reduced revenues, while pension funds and annuity providers, for example, would gain financially.

The existence of potential winners and losers from unanticipated changes in longevity, increases or decreases, provides a situation in which risk swapping can be used to reduce or even eliminate longevity risk. Since a distribution of outcomes (risk) of a potential “supplier” is usually different from the distribution of outcomes of a potential “demander” such a swap may carry a high load of “basis” risk. Thus, a portfolio of “demanders” and a portfolio of “suppliers” can be created to diversify the risk within each group. The exchange of risk between the two portfolios will carry a smaller amount of basis risk.

In one embodiment of the invention, a method is provided comprising: purchasing a first bond from a first entity; and selling a second bond to a second entity; wherein said first bond pays periodic interest payments until a first maturity date, said first maturity date being linked to a first statistic related to longevity; and wherein said second bond pays periodic interest payments until a second maturity date, said second maturity date being linked to a second statistic related to longevity. Variations of the embodiment, include that: an interest rate for the periodic interest payments paid by the first bond is a lower rate than an interest rate for a bond with a fixed maturity date, the interest rate on the first bond is greater than the interest rate on the second bond, the first maturity date is the same as the second maturity date, the first statistic is a longevity index, the first statistic is a survival rate of a specified cohort, the first statistic is the same as the second statistic, the first entity benefits from increased longevity, and the second entity benefits from decreased longevity.

Another embodiment of the invention provides a method comprising: purchasing an income stream from a first entity in exchange for a payment, wherein the first entity benefits from an increase in longevity, and wherein the income stream is payable for a first term based on a first longevity benchmark; issuing a financial instrument to a second entity, wherein the second entity benefits from a decrease in longevity; receiving a premium from the second entity in exchange for the financial instrument; receiving from the first entity, the income stream for the first term; and paying the second entity a periodic payment related to the financial instrument for a second term based on a second longevity benchmark. Variations of the embodiment include selecting the first entity and the second entity based on a correlation of the first entity's benefit from the increase in longevity and the second entity's benefit from the decrease in longevity, that the first longevity benchmark and the second longevity benchmark are the same, the first longevity benchmark and the second longevity benchmark are different, the first longevity benchmark and second longevity benchmark comprise a percentage of survivors in a cohort, and the financial instrument comprises at least one of the group of: bond, option, swap, and derivative contract.

Another embodiment of the invention provides a method comprising: purchasing an asset from a first entity, wherein the first entity benefits from an increase in longevity; entering into a swap agreement with the first entity, wherein the swap agreement has a swap rate based on a first longevity benchmark; issuing a financial instrument to a second entity, wherein the second entity benefits from a decrease in longevity; and paying the second entity a payment associated with the financial instrument, the payment based on a second longevity benchmark. Variations of the embodiment include that the financial instrument comprises a bond, the swap rate comprises a difference between a realized survival rate and an anticipated survival rate of the first longevity benchmark, paying the second entity an additional payment based on the realized survival rate and the anticipated survival rate of the first longevity benchmark, selecting the first entity and the second entity based on a correlation of the first entity's benefit from the increase in longevity and the second entity's benefit from the decrease in longevity.

Another embodiment of the invention provides a method comprising: hedging a financial instrument based on life expectancy via a swap agreement with an issuer of the financial instrument, wherein the swap agreement has a swap term based on a longevity benchmark; holding a portfolio of assets associated with an entity that benefits from an increase in longevity; and minimizing a basis risk associated with the hedge by correlating a benefit to the issuer from a decrease in longevity and the benefit to the entity from the increase in longevity. Variations of the embodiment include hedging a financial instrument comprises issuing a second financial instrument to a second entity, wherein the second entity benefits from a decrease in longevity, and wherein the second financial instrument has a maturity term associated with a second longevity benchmark; minimizing the basis risk comprises a calculation using the formula:

hedge ratio=ρσ(CFS)/σ(CFD);

and the longevity benchmark comprises a percentage of cohort survival.

### BRIEF DESCRIPTION OF THE DRAWINGS

FIG. 1 depicts a diagram of entities in a transaction for managing longevity risk, according to an embodiment of the invention; and

FIG. 2 depicts a flow chart of a transaction according to an embodiment of the invention.

### DETAILED DESCRIPTION

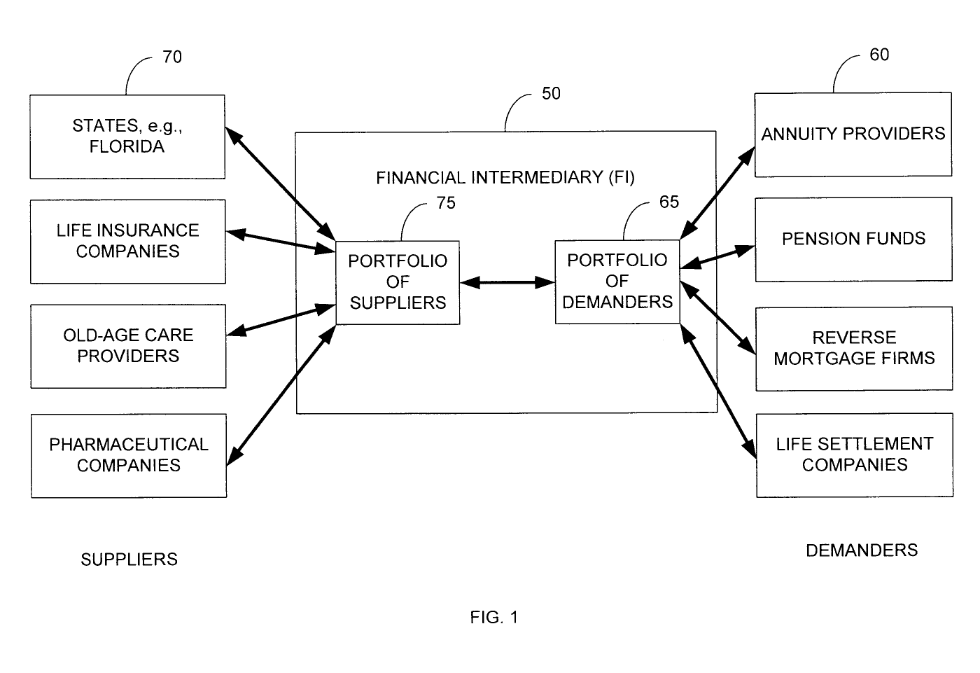

Embodiments of the invention relate to managing longevity risk. Such embodiments comprise an innovative intermediation process, which can involve entities as shown in FIG. 1. As depicted in FIG. 1, a financial intermediary (FI) 50 is provided that is designed to reduce or transfer longevity risk between a first entity and a second entity. The risk reduction/transfer process, directed to bringing into the retirement markets those players who benefit financially from faster than expected increased longevity and lose from a lower than expected increase in longevity, provides a basis for a longevity-risk market. One reason that such a longevity risk market has not yet been created is that only the risk of unanticipated increases, and not decreases, in longevity has been addressed. There has not been a focus on entities that could gain from faster than anticipated increases in longevity, and lose from slower than anticipated increases in longevity. Risk reduction arrangements described herein between second and first entities which are on different sides of the longevity risk spectrum may also attract investors/speculators who can play a stabilizing role by adding liquidity and depth to the longevity market.

One or more first entities (“suppliers”) 70 are typically entities that benefit from an increase in longevity of a certain cohort, such as old-age care providers, pharmaceutical companies, certain districts that may have a relatively large population of aged individuals, life insurance companies, etc. One or more second entities (“demanders 60”) are typically entities that benefit from a shorter than expected lifespan of a certain cohort, for example, annuity providers, pension funds, life settlement firms, reverse mortgage firms, etc.

In some embodiments, facilitating the risk transfer is provided using the financial intermediary (FI) 50. The FI 50 can be a special purpose vehicle, trust, or other entity operable to employ financial innovations to create portfolios, e.g., a portfolio of suppliers 75 and a portfolio of demanders 65, or other portfolio, and combine them in a way that minimizes basis risk at a minimum cost to the FI. In some embodiments, the risk is managed by enabling a transfer and reduction of risk of unexpected changes in longevity from one or more entities to another entity or entities.

Various transactions may be provided using the FI via different types of contracts and financial instruments. Such contracts may include instruments such as spot and future longevity and survival bonds, arrangements such as longevity swaps, and longevity options. These contracts may be based on one or more specified longevity indices or benchmarks. One exemplary contract may have the terms as shown in the Term Sheet of Appendix A.

In an exemplary intermediation process, longevity risk may be transferred from a demander 60 or supplier 70 to an FI 50 for a premium which can compensate the FI 50 for undertaking the longevity risk. The FI 50 may minimize its exposure to the longevity risk it will assume by diversifying its assets and liabilities across one or more demanders and suppliers. The rate of return on the capital of the FI 50 may be affected by the size of the premium (the intermediation gap), a scale of its operations relative to its capital needs (the leverage), a cost of raising capital, operational efficiency, or other factors.

Ways in which longevity risk may be mitigated include creation of innovative financial instruments, and strategies and contracts designed to facilitate the reduction/transfer of risk from one entity to another (e.g. bonds, options, swaps and other derivatives). Such financial instruments may refer to one or more longevity indices or benchmarks.

In exchange for providing a hedge to second entities/demanders against unanticipated increase in longevity, first entities/suppliers 70 (such as the state of Florida) may acquire at least a partial hedge against unanticipated decreases in longevity. The exchange between the parties on both sides of the longevity risk spectrum will not be provided directly but will be carried out through an FI 50. Arrangements via an FI 50, which may have a high rating due to risk pooling and regulatory arrangements, will typically provide an efficient, risk reducing and beneficial outcome for all entities involved in a transaction.

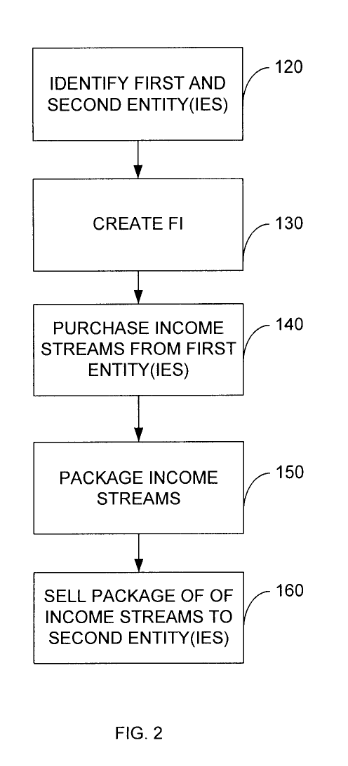

In one or more embodiments of the invention, a hedge is established according to the flowchart of FIG. 2. First entities/suppliers and second entities/demanders are identified (step 120). Suppliers are entities that benefit from an increased or longer than expected lifespan of a certain group/cohort. Suppliers or first entities can be, for example, old-age care providers, pharmaceutical companies, states such as Florida or Arizona, life insurance companies, and others. Second entities are typically entities that may be at risk of financial losses in the event of longer than expected longevity. Such second entities can be, for example, annuity providers, pension funds, life settlement firms, reverse mortgage firms, and others.

In an embodiment, an FI is created (step 130). The FI may purchase certain income streams from the first entities and sell income streams to second entities (step 140). The income streams can be, for example, bond payments which may pay a specified interest rate in periodic payments for a term. The FI may be created at the same time that the second and first entities are identified, or at another time. The FI may also be an existing entity that had been created at a prior time that is designated for a transaction involving the identified second and first entities.

Since first entities/suppliers often have a high positive correlation with longevity, the income streams purchased by the FI can be packaged into a financial product, (step 150), and sold by the FI to second entities/demanders, (step 160). One example of the packaged financial product can be another bond. In such a process, the longevity risk is transferred from second entities/demanders to the first entities/suppliers by the FI in the intermediation process. In this process the FI may incur “basis” risk for which it will be compensated. A payment term may be linked to one or more longevity indices or benchmarks (e.g., mortality/morbidity rates for a cohort) or to a survival rate of a certain cohort (e.g., 98% of 65 year old living for a particular term). Such benchmark, index or other relevant data may be supplied by one or more sources such as the United States Census Bureau, the National Vital Statistics Office of the United Kingdom, JP Morgan's Life Matrix Index, etc.

Since survivorship of a cohort cannot be definitively established in advance, a payment term end date may not be established in advance and may depend on some realization of mortality/longevity. If the survivorship rate turns out to be greater than anticipated, the payment term end will be at a later date. In exchange for the income streams purchased from the first entities/suppliers, the

FI will transfer to the first entities/suppliers a lump sum (or other payment), e.g., by purchasing a bond issued by a supplier. The income streams may be linked to an index, rate, or other benchmark, e.g., a survival rate of a cohort, such as a second population of 65 year olds. The FI will receive a lump sum from the second entities/demanders and in effect selling them a bond that will make payments to these entities also linked to an index. To minimize its basis risk the FI may weigh its commitments to both sides (demanders and suppliers) depending on the correlation that the two portfolios (demanders and suppliers) have with each other.

In general the index/benchmark used to calculate payments from the FI to the first entity is different from an index or benchmark used to calculate payments made on the financial instrument sold by the FI to the second entity. In this case, the FI must assume risk, and is compensated accordingly.

Some steps that the FI may undertake in a transaction according to embodiments of the invention, which may also minimize uncertainty and improve spread or returns, are the following. The FI can compare a set of potential demanders and potential suppliers and estimate annual cash flows to be paid by the demanders to a given cohort over their remaining lifetime. The FI may similarly estimate annual income to be earned by the suppliers, from a cohort with the same life expectancy as the above, over their remaining lifetime. The FI may then package (e.g., by combining) the cash flows of demanders and determine a cash flow for the packaged demanders. To obtain a minimum variance package, the FI may use a variance minimization program that runs through the various proportions needed to obtain that minimum. The FI can then combine income streams of suppliers and obtain a minimum variance package using the same (or other) methodology as used for the demanders.

The demander package constructed by the FI may dictate the price that the FI requires in order to provide a stream of payments to a given set of second entities (demanders). In effect demanders are buying a financial instrument that can be the equivalent of a bond (or other asset structure) that is linked to a benchmark or index that may be related to life expectancy or survival rates. The FI will make coupon payments which carry, in effect, a lower rate than the non-linked comparable bonds. A package of supplier income streams constructed by the FI dictates the price paid for the bond and the payments made on the bond, which are promised, typically as future annual payments paid by the FI using the income streams received from the suppliers. The index or benchmark may be a longevity index, or a cohort survival rate for example.

The difference between a price that is paid for a life expectancy-linked bond to the suppliers and the price that the demanders pay is the spread that compensates the FI for the basis risk undertaken by the FI. This risk essentially depends on the correlation between the demander package and the supplier package. The closer the correlation of these two packages is to 1, the smaller the basis risk and the greater the likelihood that the FI will make a profit. One way to obtain a high correlation is on one hand to find demanders where the payments due to the demanders, from the FI, have a low average covariance and to find suppliers where the payments (income streams) transferred to the FI have a low average covariance. For example, a portfolio of pension funds across countries has a lower average covariance than pension funds in the same geographical location. Or, a portfolio of “suppliers” which contains pharmaceutical cos. and states like Florida will have a lower covariance than just states with older population.

The FI's goal is to combine the demander payments and supplier payments in an optimal way to provide the lowest possible basis risk which is assumed by the FI. Exemplary equations for calculating such payments and arrangements are provided in Appendix B. The equations are using the time series data on income streams of suppliers and of demanders. The procedure will search for the proportion attached to each supplier that minimizes the variance of the income streams of the portfolio of suppliers. The same procedure is applied to the demanders. Once these proportions are identified a time series of the portfolios income streams will be generated. There will then be a time series of the combined income streams of the suppliers and another one for the demanders. These two time series will then be correlated to estimate the basis risk and find the optimal ratio of suppliers vs. demanders that the FI would like to engage such that the FI minimizes its “basis” risk as seen in the last equation in Appendix B.

### REFERENCE INDICES

A reference index may be used as a basis or benchmark for financial instruments structured according to some embodiments of the invention. The reference index can be related to longevity or survival, and can be based on indices published by public agencies such as the Census Bureau and the National Vital Statistics (NVS) offices in the US, National Statistics Office (NOS) in the UK, Bureau of Statistics in Israel, and similar local, regional, national, and international statistics such as the WHO, a commercial longevity index, e.g., JP Morgan Life Matrix Index, or other existing or specially-created indices agreed to among the entities in a transaction.

There may be several reference indices appropriate for the proposed arrangements. In some embodiments, related indices can be used. For example, a “survivorship” index published regularly by official national statistical authorities may be used to provide information on the proportion of people of a certain cohort that have survived, such as a certain percentage of 85 year olds. Such an index also may include information on the projected survivorship for the same cohort a year or more ahead. The survivorship index may be used with a first index, e.g., a “longevity” index, published in some countries at a certain frequency, which provides information relating to the life expectancy of a certain cohort.

Basis Risk

The effectiveness of an arrangement between the FI and the demanders and suppliers may depend largely on the correlation between the gains/losses of the demander/supplier portfolios with which the FI is engaged. In general, the higher a correlation between the cash flows of the demanders and suppliers the smaller the resulting basis risk for the FI. The cash flow correlation may be determined largely by exogenous factors but could also be affected by structure/design of the transactions between the parties. Selection of appropriate entities and/or a reference index, for example, can improve the correlation, thereby reducing basis risk to a minimum.

Inflation Risk

Even modest inflation rates pose a serious threat to pensioners' wealth and their means of existence in retirement years. In order to cope with this risk, the FI may use its capital to buy Unites States Treasury Inflation Protected Securities (TIPS), or other securities, to provide an inflation protection feature to FI transactions and financial products, e.g., a longevity bond.

Exemplary details of embodiments of the invention are provided in the following examples.

### EXAMPLE 1

On Nov. 18, 2004, Florida's Division of Bond Finance (DBF)—Florida's debt agency—issued $172 million in AAA bonds. Each bond pays interest every June 1 and December 1 and matures in 2024. The final principal payment is $1 million. An FI may purchase the entire bond issue and DBF and FI may enter into the following swap agreement:

1) Every five years a percentage difference between the realized survival rate and the anticipated survival rate (in a prior five years period), based on a reference index, may be used as the swap rate. If the realized survival rate of a specified cohort exceeds the expected one, then DBF will transfer to FI an amount equivalent to the swap rate times the notional amount compounded by the prevailing interest rate at each five year increment in the prior five year term. If the reverse occurs, then the FI will transfer an equivalent amount to DBF.

2) FI in turn will issue a survival linked bond to pension funds. This bond will be linked to a survival index, which may be the same reference index used in the swap agreement, or another index. The bond will pay a fixed interest rate that is a lower rate than an interest rate of the DBF bonds until a maturity date which is specified by a statistic of the survival index, e.g., survival rate of a specified cohort. Settlement may be periodic and based on the same time increments as the swap agreement or the DBF bond.

In this example, which is based on a single issuer (the state of Florida Division of Bond Finance), the transaction would allow pooling together several issuers, which may not be highly correlated. FI is likely to get a high credit rating which will enable FI to issue its bonds at higher prices with lower rates.

### EXAMPLE 2

A bank offers individuals a long term savings (e.g., withdrawal) plan in which an individual exchanges a lump sum for a stream of monthly payments for 20 years. The principal and the coupon are amortized over the 20 years. After 20 years the individual will continue receiving the same monthly payments for a period to be determined at the end of the 20 years. The length of that period will be determined by the remaining life expectancy of the 85 years old cohort, in 20 year's time. Alternatively the remaining life expectancies to which the plan is linked may be national expectancies that are published by relevant national statistics authorities.

To hedge its risk the bank may engage in a swap agreement with the FI that is holding a portfolio of suppliers (e.g., the state of Florida, chain of nursing homes, pharmaceuticals and life insurance companies.) The savings plan in this example may be different from a regular life annuity because, unlike an annuity, those who die earlier will not subsidize those who live longer. This is a significant advantage of the individual plan over regular annuities.

Rate of Return on FI Capital

The rate of return on the capital of an FI may depend on several factors: (a) a premium charged (the intermediation spread); (b) scale of operations relative to its capital (the leverage); (c) cost of raising capital; and/or (d) operational efficiency. Each of these factors may depend on the effectiveness of implementation. If the FI is successful in identifying and purchasing from suppliers streams of income that may be desired by demanders, a premium or spread received/earned by the FI will be larger. The more successful the FI is in minimizing the risk it undertakes, the less capital it will need to maintain, and the higher the resulting leverage. Since a return on FI activity may have a low correlation with returns on other financial market assets (shares, bonds, etc.), capital raised by the FI in the form of participation notes, for example, is likely to be attractive to investors for diversification purposes. This is likely to lower the cost of capital to the FI. Greater operational efficiency of the FI further increases the attractiveness of such an investment.

Other FI Activities

In addition to its main intermediation role, the FI also may provide the following in one or more transactions in embodiments of the invention:

(a) Issue equity—which can consist of participation shares issued to institutional investors, or other investors. An attractive novel feature of these shares is that their correlation with other investments will be low. This will, among other things, increase the ability of investors to diversify risk.

(b) Reduce credit risk. One goal of the FI is to be an intermediary for many entities on both sides, in particular the borrowers (states, in one embodiment), thereby reducing credit risk due to diversification. Due to the generally low correlation among the entities to which the FI will lend, the FI will be able to lend money to entities that may have lower credit ratings, while the FI will maintain a high credit rating.

(c) Engage in market making activities. By being a market maker in longevity bonds, the FI can contribute to developing a liquid market for longevity-linked instruments. Expanding the market to include investors and players who are not necessarily looking to hedge their commitments will reduce risk premiums, which in turn will make the FI's longevity bonds (or other financial instruments or assets) more attractive to market participants.

It will be appreciated that the present invention has been described by way of example only, and that the invention is not to be limited by the specific embodiments described herein. Improvements and modifications may be made to the invention without departing from the scope or spirit thereof

Embodiments of the present invention may comprise software and computer components and software and computer-implemented steps that will be apparent to those skilled in the art. For example, calculations, recording and communications can be performed, stored and transmitted electronically.

For ease of exposition, not every step or element of the present invention is described herein as part of a software or computer system, but those skilled in the art will recognize that each step or element may have a corresponding computer system or software component. Such computer system and/or software components are therefore enabled by describing their corresponding steps or elements (that is, their functionality), and are within the scope of the present invention.

### APPENDIX A

### Exemplary Term Sheet

FI will enter into the following type of agreements with “suppliers” as given in the following example applied to one of the suppliers.

The FI will give the state of Florida (SF) 10 million dollars (the FI buys a bond), on Jan. 1, 2008 with the following terms:
SF will make semi annual interest payments of 4% to the FI where the number of years is linked to the survival rate of the national cohort of 65 year olds. When the survival rate of this cohort reaches 5% the “bond” would be retired. I.e. the Principal payment of 10 million will be returned.

The FI will enter into another agreement with “demanders” as shown in the example applied to one of the demanders.

The FI will receive from the CALPERS 10 million dollars (the FI sells a bond), on Jan. 1, 2008 with the following terms:
The FI will make semi annual payments of 3.5% to CALPERS where the number of years is linked to the survival rate of the state of California cohort of 65 year olds. When the survival rate of this cohort reaches 5%, the “bond” would be retired. I.e. the Principal payment of 10 million will be returned.

### APPENDIX B

Minimizing “Basis” Risk by the FI

1. Minimize “Suppliers” (N) cashflow volatility (σᵢ)

Choose P (proportion) to:

$$\begin{matrix}Minimize {\sum }_{i = 1}^{N} {\sum }_{i = 1}^{N} {P}_{i} {P}_{j} {σ}_{ij} \\ Subject to & \\ {\sum }_{i = 1}^{N} {P}_{i} = 1 & ( 1 ) \\ {P}_{i} \geq o \\ i = 1 , … , N & ( 2 )\end{matrix}$$

2. Minimize “Demanders” (M) cashflow volatility (σₖ)

Choose P (proportion) to:

$$\begin{matrix}Minimize {\sum }_{k = 1}^{M} {\sum }_{l = 1}^{M} {P}_{k} {P}_{l} {σ}_{kl} \\ Subject to & \\ {\sum }_{k = 1}^{M} {P}_{k} = 1 & ( 1 ) \\ {P}_{k} \geq 0 \\ k = 1 , … , M & ( 2 )\end{matrix}$$

3. Minimize “basis” risk: Hedge ratio, h*, proportion of cashflow from “demanders” to “suppliers”

Minimize σ²(CFS−hCFD)=σ²(CFS)+h²σ²(CFD)−2hCov(CFS,CFD)

Solution: h*=ρσ(CFS)/σ(CFD) ρ−correlation

CFS(Cashflow−Suppliers) CFD(Cashflow−Demanders)

What is claimed is:

1. A method comprising:
purchasing a first bond from a first entity; and
selling a second bond to a second entity;
wherein said first bond pays periodic interest payments until a first maturity date, said first maturity date being linked to a first statistic related to longevity; and
wherein said second bond pays periodic interest payments until a second maturity date, said second maturity date being linked to a second statistic related to longevity.

2. The method of claim 1 wherein an interest rate for the periodic interest payments paid by the first bond is a lower rate than an interest rate for a bond with a fixed maturity date.

3. The method of claim 1 wherein the interest rate on the first bond is greater than the interest rate on the second bond.

4. The method of claim 1 wherein the first maturity date is the same as the second maturity date.

5. The method of claim 1 wherein the first statistic is a longevity index.

6. The method of claim 1 wherein the first statistic is a survival rate of a specified cohort.

7. The method of claim 1 wherein the first statistic is the same as the second statistic.

8. The method of claim 1 wherein the first entity benefits from increased longevity.

9. The method of claim 1 wherein the second entity benefits from decreased longevity.

10. A method comprising:
purchasing an income stream from a first entity in exchange for a payment, wherein the first entity benefits from an increase in longevity, and wherein the income stream is payable for a first term based on a first longevity benchmark;
issuing a financial instrument to a second entity, wherein the second entity benefits from a decrease in longevity;
receiving a premium from the second entity in exchange for the financial instrument;
receiving from the first entity, the income stream for the first term; and
paying the second entity a periodic payment related to the financial instrument for a second term based on a second longevity benchmark.

11. The method of claim 10, further comprising: selecting the first entity and the second entity based on a correlation of the first entity's benefit from the increase in longevity and the second entity's benefit from the decrease in longevity.

12. The method of claim 10 wherein the first longevity benchmark and the second longevity benchmark are the same.

13. The method of claim 10 wherein the first longevity benchmark and the second longevity benchmark are different.

14. The method of claim 10 wherein the first longevity benchmark and second longevity benchmark comprise a percentage of survivors in a cohort.

15. The method of claim 10, wherein the financial instrument comprises at least one of the group of: bond, option, swap, and derivative contract.

16. A method comprising:
purchasing an asset from a first entity, wherein the first entity benefits from an increase in longevity;
entering into a swap agreement with the first entity, wherein the swap agreement has a swap rate based on a first longevity benchmark;
issuing a financial instrument to a second entity, wherein the second entity benefits from a decrease in longevity; and
paying the second entity a payment associated with the financial instrument, the payment based on a second longevity benchmark.

17. The method of claim 16 wherein the financial instrument comprises a bond.

18. The method of claim 16 wherein the swap rate comprises a difference between a realized survival rate and an anticipated survival rate of the first longevity benchmark.

19. The method of claim 18 further comprising paying the second entity an additional payment based on the realized survival rate and the anticipated survival rate of the first longevity benchmark.

20. The method of claim 16, further comprising: selecting the first entity and the second entity based on a correlation of the first entity's benefit from the increase in longevity and the second entity's benefit from the decrease in longevity.

21. A method comprising:
hedging a financial instrument based on life expectancy via a swap agreement with an issuer of the financial instrument, wherein the swap agreement has a swap term based on a longevity benchmark;
holding a portfolio of assets associated with an entity that benefits from an increase in longevity; and
minimizing a basis risk associated with the hedge by correlating a benefit to the issuer from a decrease in longevity and the benefit to the entity from the increase in longevity.

22. The method of claim 21 wherein hedging a financial instrument comprises issuing a second financial instrument to a second entity, wherein the second entity benefits from a decrease in longevity, and wherein the second financial instrument has a maturity term associated with a second longevity benchmark.

23. The method of claim 21 wherein minimizing the basis risk comprises a calculation using the formula:
hedge ratio=ρσ(CFS)/σ(CFD).

24. The method of claim 21 wherein the longevity benchmark comprises a percentage of cohort survival.
